(19) United States
(12) Patent Application Publication
(10) Pub. No.: US 2011/0121490 A1
(43) Pub. Date: May 26, 2011

(54) Mold Apparatus

(76) Inventors: Peng He, Taipei (TW); Xiaoping Wu, Taipei (TW); Shih-Hsiung Ho, Taipei (TW)

(21) Appl. No.: 12/625,561

(22) Filed: Nov. 25, 2009

(51) Int. Cl. B29C 45/40

(52) U.S. Cl. 264/334; 425/556

(57) ABSTRACT

A mold apparatus includes a core having a mold cavity for molding an article and a gate for allowing molten plastics to flow into the mold cavity therefrom. An ejector pin is arranged with a distal end thereof facing and adjacent to the gate. The ejector pin is movable with respect to the gate for making the distal end thereof close the gate or depart from the gate. The mold apparatus is capable of automatically separating redundant parts from an article without burrs.

### BACKGROUND OF THE INVENTION

1. Field of the Invention

The present invention relates to a mold apparatus, and more particularly to a mold apparatus which has an improved structure capable of automatically separating redundant parts from an article without burrs.

2. The Related Art

In general, a conventional mold apparatus includes a core having a mold cavity for molding an article and a gate connecting the mold cavity and a hot runner for allowing molten plastics to flow into the mold cavity therefrom.

However, the article molded by the conventional mold apparatus often has redundant parts formed in the hot runner integrated therewith after molten plastics become cooling. The redundant parts need to be separated from the article by manual operation. That not only wastes a lot of time, but also apt to burr the article. And thereafter, it has to add a process to remove the burrs from the article to guarantee the quality of the article, which virtually increases the cost of the article. Hence, it is desirable to have an improved mold apparatus capable of automatically separating redundant parts from the article without burrs to overcome the problem encountered with the prior art.

### SUMMARY OF THE INVENTION

It is an object of the present invention to provide an improved mold apparatus capable of automatically separating redundant parts from an article without burrs. The mold apparatus includes a core having a mold cavity for molding an article and a gate for allowing molten plastics to flow into the mold cavity therefrom. An ejector pin is arranged with a distal end thereof facing and adjacent to the gate. The ejector pin is movable with respect to the gate for making the distal end thereof close the gate or depart from the gate.

Another object of the present invention is to provide a method for molding an article which comprises: injecting molten plastics into a mold cavity of a mold; ejecting an ejector pin to a gate for closing the gate after the molten plastics fill in the mold cavity and before the molten plastics become cooling; drawing the ejector pin from the gate after the molten plastics become cooling; and taking out the article formed in the mold cavity.

As described above, by providing the ejector pin movable with respect to the gate for making the distal end thereof close the gate or depart from the gate, redundant plastics formed in the hot runner are automatically separated from the article molded in the mold cavity. It doesn't need manual operation to separate them any more. And moreover, the article molded by the mold apparatus of the present invention has smooth surface without burrs formed thereon.

### BRIEF DESCRIPTION OF THE DRAWINGS

The present invention will be apparent to those skilled in the art by reading the following description of an embodiment thereof, with reference to the attached drawings, in which:

FIG. 1 is a schematic cross sectional view of a mold apparatus in accordance with the present invention;

FIG. 2 and FIG. 3 are cross sectional views illustrating an operation of an ejector pin after a mold cavity filled up with molten plastics;

FIG. 4 is an enlarged view of area A shown in FIG. 2; and

FIG. 5 is an enlarged view of area B shown in FIG. 3.

### DETAILED DESCRIPTION OF THE PREFERRED EMBODIMENT

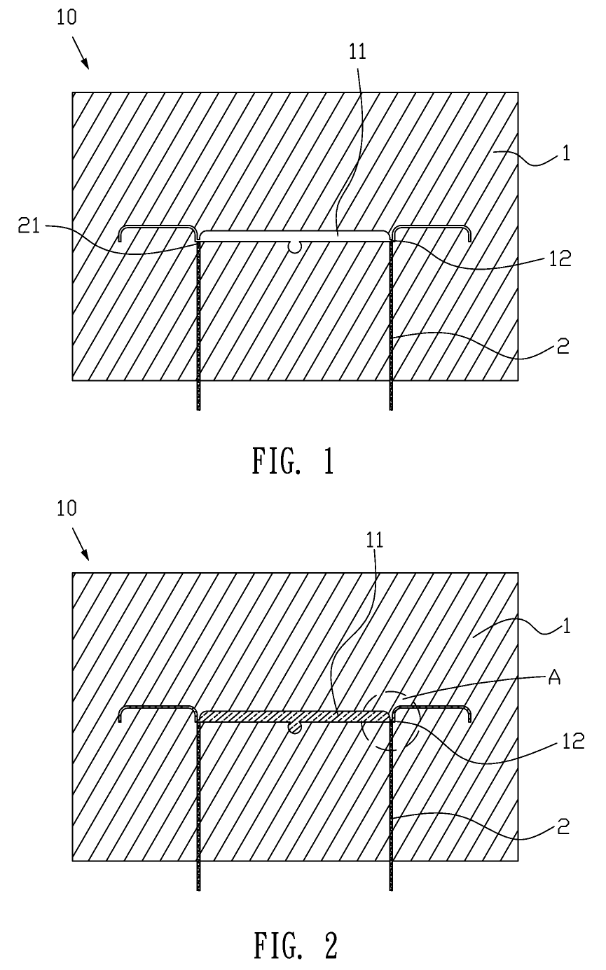

As illustrated in FIGS. 1 to 3, a mold apparatus 10 according to the present invention includes a core 1 having a mold cavity 11 for molding an article and a gate 12 connecting the mold cavity 11 and a hot runner (not shown) for allowing molten plastics to flow into the mold cavity 11 therefrom. An ejector pin 2 is arranged alignment with the gate 12 with a distal end 21 thereof facing and adjacent to the gate 12.

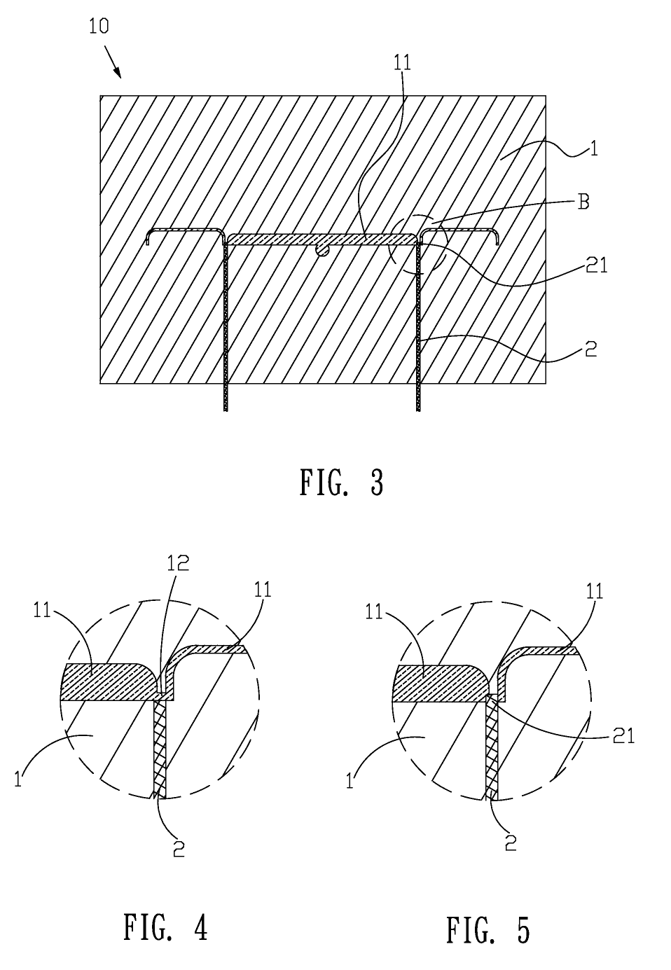

With reference to FIG. 2 and FIG. 4, in molding, molten plastics will flow into the mold cavity 11 from the gate 12. Once the mold cavity 11 is filled up with the molten plastics, the ejector pin 2 is immediately ejected out to make the distal end 21 thereof close the gate 12 before the molten plastics become cooling, as best shown in FIG. 3 and FIG. 5. After the molten plastics become cooling, the ejector pin 2 is drew back to make the distal end 21 thereof depart from the gate 12. In this case, an article molded in the mold cavity 11 and redundant plastics formed in the hot runner will be automatically separated from the article. It doesn't need manual operation to separate them any more. Furthermore, the article molded by the mold apparatus 10 will form a smooth surface without burrs thereon. As a result, the mold apparatus 10 of the present invention can help to increase work efficiency and decrease cost of the article.

Accordingly, a method for molding an article by the mold apparatus 10 of the present invention is described as follows. First, inject molten plastics into the mold cavity 11. Second, eject the ejector pin 2 to close the gate 12 after the molten plastics fill in the mold cavity and before the molten plastics become cooling. Next, draw the ejector pin 2 from the gate 12 after the molten plastics become cooling. And last, take out the article formed in the mold cavity 11.

As described above, by providing the ejector pin 2 movable with respect to the gate 12 for making the distal end 21 thereof close the gate 12 or depart from the gate 12, the redundant plastics formed in the hot runner are automatically separated from the article molded in the mold cavity 11. It doesn't need manual operation to separate them any more. And moreover, the article molded by the mold apparatus 10 of the present invention has smooth surface without burrs formed thereon.

What is claimed is:

1. A mold apparatus, comprising:
a core having a mold cavity for molding an article and a gate for allowing molten plastics to flow into the mold cavity therefrom; and
an ejector pin with a distal end thereof facing and adjacent to the gate, the ejector pin being movable with respect to the gate for making the distal end thereof close the gate or depart from the gate.

2. The mold apparatus as claimed in claim 1, wherein the ejector pin is arranged alignment with the gate.

3. A method for molding an article, comprising:
injecting molten plastics into a mold cavity of a mold;
ejecting an ejector pin to a gate for closing the gate after the molten plastics fill in the mold cavity and before the molten plastics become cooling;
drawing the ejector pin from the gate after the molten plastics become cooling; and
taking out the article formed in the mold cavity.
